(19) United States
(12) Patent Application Publication
(10) Pub. No.: US 2017/0228825 A1
(43) Pub. Date: Aug. 10, 2017

(54) COMMUNICATING WITH SENSORS AND DEVICES FOR REAL-TIME LOCATION DETECTION OF OBJECTS USING UTILITIES USAGE AND SOCIAL MEDIA INFORMATION

(71) Applicant: International Business Machines Corporation, Armonk, NY (US)

(72) Inventors: Jasbir K. DHALIWAL, Carlton (AU); Rahil GARNAVI, Macleod (AU); Timothy M. LYNAR, Box Hill (AU); John M. WAGNER, Plainville, CT (US)

(21) Appl. No.: 15/016,878

(22) Filed: Feb. 5, 2016

(51) Int. Cl. G06Q 40/08; G06Q 50/00

(52) U.S. Cl. CPC G06Q 40/08; G06Q 50/01

(57) ABSTRACT

The present disclosure relates generally to the field of dynamic risk assessment (e.g., with respect to insurance claims). In one specific example, mechanisms are provided for dynamically assessing the presence or absence of people and/or insured items of value in an insured location (e.g., an insured home). In various embodiments, systems, methods and computer program products are provided.

### BACKGROUND

The present disclosure relates generally to the field of dynamic risk assessment (e.g., with respect to insurance claims). In one specific example, mechanisms are provided for dynamically assessing the presence or absence of people and/or insured items of value in an insured location (e.g., an insured home). In various embodiments, systems, methods and computer program products are provided.

The insurance industry estimates that fraud accounts for approximately 10 percent of the property/casualty insurance industry's “incurred losses” and “lost adjustment expenses,” where this figure fluctuates based on a number of factors such as line of business, economic conditions, etc. (this estimate is based on research conducted by the Battelle Seattle Research Center for the Insurance Information Institute in 1992 (Fighting the Hidden Crime: A National Agenda to Combat Insurance Fraud. Insurance Information Institute, March 1992) and other industry reports (including Insurance Fraud, Renewing the Crusade, Conning, 2001)).

Excessive and/or fraudulent claims have led to undesirable impact on insurance companies as well as the consumers.

### SUMMARY

Through dynamic assessment of the presence or absence of people and/or other insured items of value in an insured location (e.g., in an insured home), various embodiments of the present disclosure can help lessen the effects of the excessive and/or fraudulent claims problem mentioned above.

In one embodiment, a computer-implemented method for assessing whether an insured object was at a location at a particular time is provided, the method comprising: obtaining by a processor, via a first communication network coupled to at least one utility sensor, real-time utility usage data, wherein the at least one utility sensor is at the location; obtaining by the processor, via a second communication network coupled to at least one mobile device in operative communication with at least one social media server computer, real-time social media data, wherein the at least one mobile device comprises a GPS for reporting a position of the mobile device; obtaining, by the processor, an insurance claim of a loss associated with the insured object, wherein the insurance claim specifies that the insured object was at the location at the particular time; analyzing, by the processor, at least the obtained utility usage data and the obtained social media data to determine whether the insured object identified in the insurance claim was at the location at the particular time; and outputting, by the processor, an indication of the determination whether the insured object identified in the insurance claim was at the location at the particular time.

In another embodiment, a computer readable storage medium, tangibly embodying a program of instructions executable by the computer for assessing whether an insured object was at a location at a particular time is provided, the program of instructions, when executing, performing the following steps: obtaining, via a first communication network coupled to at least one utility sensor, real-time utility usage data, wherein the at least one utility sensor is at the location; obtaining, via a second communication network coupled to at least one mobile device in operative communication with at least one social media server computer, real-time social media data, wherein the at least one mobile device comprises a GPS for reporting a position of the mobile device; obtaining an insurance claim of a loss associated with the insured object, wherein the insurance claim specifies that the insured object was at the location at the particular time; analyzing at least the obtained utility usage data and the obtained social media data to determine whether the insured object identified in the insurance claim was at the location at the particular time; and outputting an indication of the determination whether the insured object identified in the insurance claim was at the location at the particular time.

In another embodiment, a computer-implemented system for assessing whether an insured object was at a location at a particular time is provided, the system comprising: a processor; and a memory storing computer readable instructions that, when executed by the processor, implement: obtaining, via a first communication network coupled to at least one utility sensor, real-time utility usage data, wherein the at least one utility sensor is at the location; obtaining, via a second communication network coupled to at least one mobile device in operative communication with at least one social media server computer, real-time social media data, wherein the at least one mobile device comprises a GPS for reporting a position of the mobile device; obtaining an insurance claim of a loss associated with the insured object, wherein the insurance claim alleges that the insured object was at the location at the particular time; analyzing at least the obtained utility usage data and the obtained social media data to determine whether the insured object identified in the insurance claim was at the location at the particular time; and outputting an indication of the determination whether the insured object identified in the insurance claim was at the location at the particular time.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a block diagram of a system according to an embodiment.

FIG. 2 depicts a flowchart of a method according to an embodiment.

FIG. 3 depicts a block diagram of a system according to an embodiment.

FIG. 4 depicts a block diagram of a system according to an embodiment.

### DETAILED DESCRIPTION

In one example, one or more systems may provide for dynamically assessing the presence or absence of people and/or insured items of value in an insured location (e.g., an insured home). In another example, one or more methods may provide for dynamically assessing the presence or absence of people and/or insured items of value in an insured location (e.g., an insured home). In another example, one or more algorithms may provide for dynamically assessing the presence or absence of people and/or insured items of value in an insured location (e.g., an insured home).

In another example, mechanisms may be provided to allow people (e.g., insurance policy holders) to “opt in” and allow the real-time data collection described herein (with full knowledge that the various data collection devices would be utilized as taught herein).

As described herein, mechanisms are provided for dynamically assessing the presence or absence of people and/or insured items of value at a location (e.g., in an insured home). In this regard, people are increasingly producing data via the use of, for example, mobile and smart devices. Various embodiments leverage the data to determine the location of individuals (such as insured individuals) and/or connected assets (such as automobiles) and/or insured assets (such as jewelry or other items of value).

In various embodiments, the mechanisms disclosed herein take into account one or more of the following factors over a period of time: (a) data from claimant; (b) data from sensors and surveillance devices (e.g. video cameras, motion detectors, light sensors, etc.); (c) data regarding usage of utilities (e.g. electricity, gas, water, etc.); (d) data from smart appliances (e.g. those containing GPS and/or computer processor); (e) data from items of value (e.g., automobiles); (f) data from wearable and/or portable devices (e.g. cell phones, portable tablet devices, portable reading devices, etc.); (g) data from medical and/or location monitoring devices (e.g. heart monitors, GPS trackers, etc.); and/or (h) data from social media tools (e.g. FACEBOOK, TWITTER, etc.)

For the purposes of describing and claiming the present invention the term “real-time” (such as used in the context of “real-time data”) is intended to refer to occurring substantially contemporaneously with an event (but not necessarily at precisely the exact same time).

For the purposes of describing and claiming the present invention the term “social media server computer” is intended to refer to a hardware component of a computer network or the like (such as a social media network) on which people share information about themselves (for example, their current activities and their current locations) and interact with other users of the social media network.

For the purposes of describing and claiming the present invention the term “utility” (such as used in the context of “utility usage data”) is intended to refer to a product or service delivered to a fixed location. In various examples, a utility may be one of: (a) an electric utility; (b) a natural gas utility; (c) a propane utility; (d) an oil utility; (e) a cable television utility; (f) a water utility; and/or (g) an Internet access utility.

For the purposes of describing and claiming the present invention the term “insurance” is intended to refer to an arrangement by which a company or the state undertakes to provide a guarantee of compensation for specified loss in return for payment of a specified premium.

For the purposes of describing and claiming the present invention the term “premium” is intended to refer to an amount to be paid for a contract of insurance.

For the purposes of describing and claiming the present invention the term “incurred losses” is intended to refer to the total amount of paid claims by an insurer and loss reserves associated with a particular time period.

For the purposes of describing and claiming the present invention the term “lost adjustment expense” is intended to refer to the cost of investigating and adjusting losses.

Reference will now be made to an example implementation according to one embodiment. In this example implementation, User A and family live in an affluent suburb on the outskirts of Town X. They have insured themselves and many of their assets. One morning, User A is having an early meal with a friend at a cafeteria. User A uses his smart phone to take a picture of himself (a “selfie”) and User A then uploads the “selfie” to a social media server computer (User A shares his location using the geo-social Check in feature of the social network). In addition, User A's spouse, User B, leaves their home to attend a social event. User B is wearing her antique jewelry. User B drives to the social event in her “smart automobile” (which includes Internet connectivity and at least one of: (a) an audio sensor for collecting audio information from inside and/or outside the automobile; and (b) a video sensor for collecting video information from inside and/or outside the automobile). Further, their son, User C, goes out of their house for a jog at a nearby park. User C is jogging while wearing his health wrist band. Further still, their daughter, User D, is in the backyard of the house working on her science project. While outside, User D sees smoke from the house and calls the fire department.

The fire fighters arrive and successfully put out the fire. Upon inspecting the property after the fire is put out, User A writes down the people that are hurt and the assets that are lost or damaged due to the fire.

A claim processing entity, such as User A's insurance company, investigates the validity of User A's claim by analyzing data available from all its sources (including those described herein) to determine the location of the people and the assets at the time of the fire. An example of such an analysis is shown in Table 1 below.

TABLE 1

| | Location | | | |
|---|---|---|---|---|
| Person/Asset | Incident | Current | Source | Observation |
| User B | Town Y | ? | Sensors attached | Detected User B's voice in |
| | | | to smart | the automobile when the |
| | | | automobile | vehicle was leaving the |
| | | | | home's garage to go to |
| | | | | Town Y. |
| Antique | On User B, | ? | Home | Time stamp on images show |
| Jewelry | Town Y | | surveillance | User B leaving home |
| | | | device | wearing antique jewelry. |
| Pet | In smart | ? | Sensors attached | Detected sounds of barks in |
| | automobile | | to smart | the automobile when the |
| | | | automobile | vehicle was leaving the |
| | | | | home's garage to go to |
| | | | | Town Y. |
| Expensive | On User A, | ? | FACEBOOK | Time stamp and location of |
| Watch | Town Z | | | User A's “selfie” picture |
| | | | | puts the watch at the |
| | | | | cafeteria. |
| Painting | ? | Home | Home | No painting previously |
| | | | surveillance | existed in the home's half |
| | | | device | burnt living room as |
| | | | | claimed by User A. |

Looking at Table 1, the insurance company can match the claimant's assertions with sensor (and other) device accessed information to determine that the claimant, User A, has made several fraudulent assertions:
1. User A has asserted that User B was burnt in the fire. However, the data indicates that at the time of the fire, User B's voice was heard in the automobile while she was travelling from the house to Town Y.
2. User A has asserted that User B's antique jewelry was burnt in the fire. However, the data indicates that at the time of the fire, User B had left the home wearing the antique jewelry.
3. User A has asserted that the pet was burnt in the fire. However, the data indicates that at the time of the fire, the pet's barking was heard in User B's automobile while she was travelling from the house to Town Y.
4. User A has asserted that his expensive name-brand watch was burnt in the fire. However, the data indicates that at the time of the fire, User A was seen in the “selfie” photograph wearing this watch at the cafeteria.
5. User A has asserted that a painting in the house was damaged in the fire. However, the data indicates that at the time of the fire, no such painting had existed in the location claimed by User A.

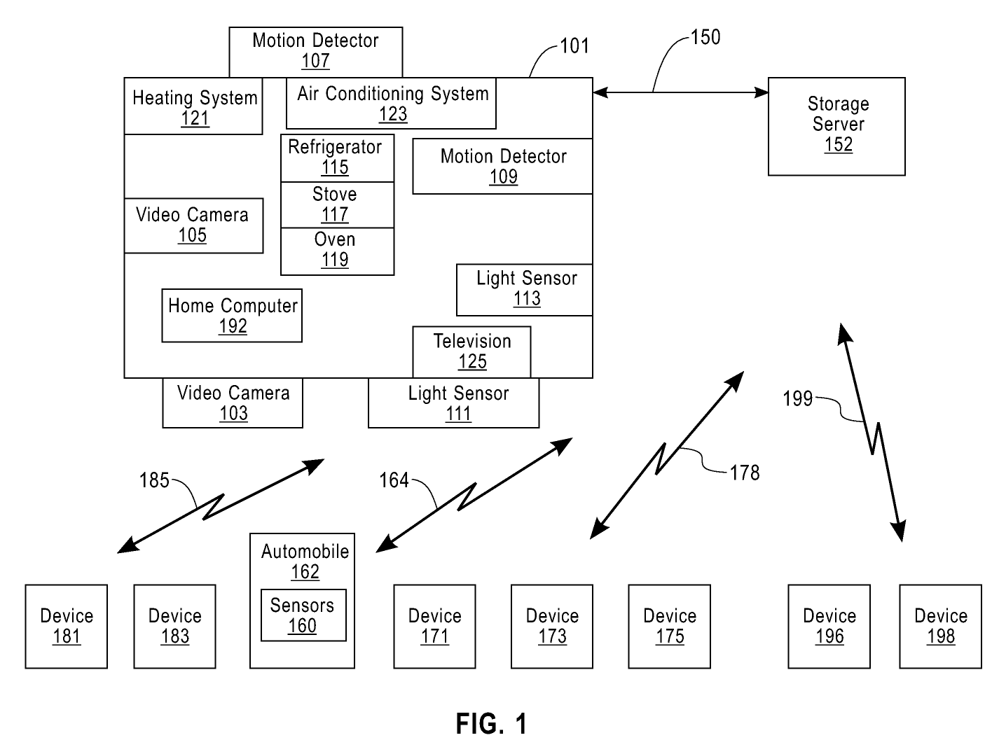

Referring now to FIG. 1, a block diagram of a system according to an embodiment is shown. As seen in this FIG. 1, a home 101 of an insured person has installed therein a wide range of sensors and surveillance devices (e.g. exterior video camera 103, interior video camera 105, exterior motion detector 107, interior motion detector 109, exterior light sensor 111, interior light sensor 113, etc.). The home 101 also includes smart household appliances (e.g., refrigerator 115, stove 117, oven 119, heating system 121, air conditioning system 123, television 125, etc.). Each of the sensors, surveillance devices and smart household appliances mentioned above contains a computer element (e.g., an embedded processor) for controlling and monitoring their use. Further, each of the sensors, surveillance devices and smart household appliances mentioned above is operatively connected to a network in the home (not shown) which provides remote access for monitoring and control (for example, security cameras monitored remotely by security companies, or appliances connected to centralized control systems which can be accessed remotely). Home 101 also consumes utilities such as electricity, water and gas, whose use is measured remotely and can be monitored in real-time. In addition, monitoring of, for example, opening and closing of doors, pet sounds, etc. is performed. Data related to each of the sensors, surveillance devices and smart household appliances mentioned above (as well as data related to the usage of utilities) is sent via a communication channel 150 to a real-time data monitoring and storage server 152 (e.g., based on previously obtained authorization from the user(s) to access the information). In one example, the communication channel 150 comprises a single communication channel. In another example, the communication channel 150 comprises a plurality of communication channels. In another example, the communication channel 150 may be wired and/or wireless. In another example, the communication channel 150 comprises the Internet. The real-time data collected and stored at server 152) can be used to detect the presence or absence of people (e.g., one or more individually identifiable person) in home 101 at a given time, as well as the presence or absence of assets (e.g., one or more individually identifiable items of value) at a given time.

Still referring to FIG. 1, sensors 160 attached to automobile 162 could detect the number of occupants (who may be individually identifiable) in the vehicle when it left, or returned to, the home's garage. Data regarding the detected occupants in the automobile is sent via a communication channel 164 to real-time data monitoring and storage server 152 (e.g., based on previously obtained authorization from the user(s) to access the information). In one example, the communication channel 164 comprises a single communication channel. In another example, the communication channel 164 comprises a plurality of communication channels. In another example, the communication channel 164 may be wired and/or wireless. In another example, the communication channel 164 comprises the Internet.

Still referring to FIG. 1, various wearable and/or portable devices 171, 173, 175 containing sensors are being integrated by people into their daily lives. Such wearable and/or portable devices may be, for example, cell phones, portable tablet devices, portable reading devices, etc. In other examples, such wearable and/or portable devices may be health wrist bands (e.g., FITBIT or ANGELSENSOR), which may be attached to a cell phone, computer or monitoring system when being read out. Further, such wearable and/or portable devices provide location information (the location may be determined at any time, such as, for example, at the time of device interrogation or recharging.) Data from the wearable and/or portable devices 171, 173, 175 is sent via a communication channel 178 to real-time data monitoring and storage server 152 (e.g., based on previously obtained authorization from the user(s) to access the information). In one example, the communication channel 178 comprises a single communication channel. In another example, the communication channel 178 comprises a plurality of communication channels. In another example, the communication channel 178 may be wired and/or wireless. In another example, the communication channel 178 comprises the Internet.

Still referring to FIG. 1, various medical devices 181, 183 containing sensors are being worn by people. Such medical devices may monitor health and/or location (e.g., location monitoring devices such as GPS trackers to find patients if they wander off). Data from the medical devices 181, 183 is sent via a communication channel 185 to real-time data monitoring and storage server 152 (e.g., based on previously obtained authorization from the user(s) to access the information). In one example, the communication channel 185 comprises a single communication channel. In another example, the communication channel 185 comprises a plurality of communication channels. In another example, the communication channel 185 may be wired and/or wireless. In another example, the communication channel 185 comprises the Internet.

Still referring to FIG. 1, home computer 192 and mobile devices 196, 198 have software running thereon that is configured to allow the users thereof to utilize social media tools (e.g. FACEBOOK, TWITTER, etc). Such social media tools allow the users to easily share their locations, such as via posts and photos. Data (e.g., obtained from the social media tools) is sent from the home computer 192 to the real-time data monitoring and storage server 152 (e.g., based on previously obtained authorization from the user(s) to access the information) via the communication channel 150. Data (e.g., obtained from the social media tools) is sent from the mobile devices 196, 198 via a communication channel 199 to real-time data monitoring and storage server 152 (e.g., based on previously obtained authorization from the user(s) to access the information). In one example, the communication channel 199 comprises a single communication channel. In another example, the communication channel 199 comprises a plurality of communication channels. In another example, the communication channel 199 may be wired and/or wireless. In another example, the communication channel 199 comprises the Internet. The data obtained from the social media tools can be used to provide evidence of the location (and/or additional information) of people and/or insured items of value.

In one specific example, the utility usage data (the data associated with the use of a utility, for example, electricity, natural gas, propane, oil, cable television, water, and/or Internet) may be used to provide evidence of one or more people being in a home at a given time based upon the amount of electricity being used at the given time, the amount of water being used at the given time, the amount of gas being used at the given time, the amount of oil being used at the given time, the level of cable television usage at the given time and/or the level of Internet usage at the given time. In another specific example, if during a given time period the temperature in the vicinity of the location of a home averaged below zero degrees and during that same given time period no (or very little) electricity, oil or gas was used at the home, then this provides evidence that there was no one living at the home during the given time period. In another example, the higher the level of utility usage at a given time, the larger the number of people in the home at the given time. In another example, a large number of phone calls might imply a large number of people living in the home. In another example, it might be inferred from the following pattern of usage that there are four people living in the home: if water usage goes up and down four times every morning for about ten minutes.

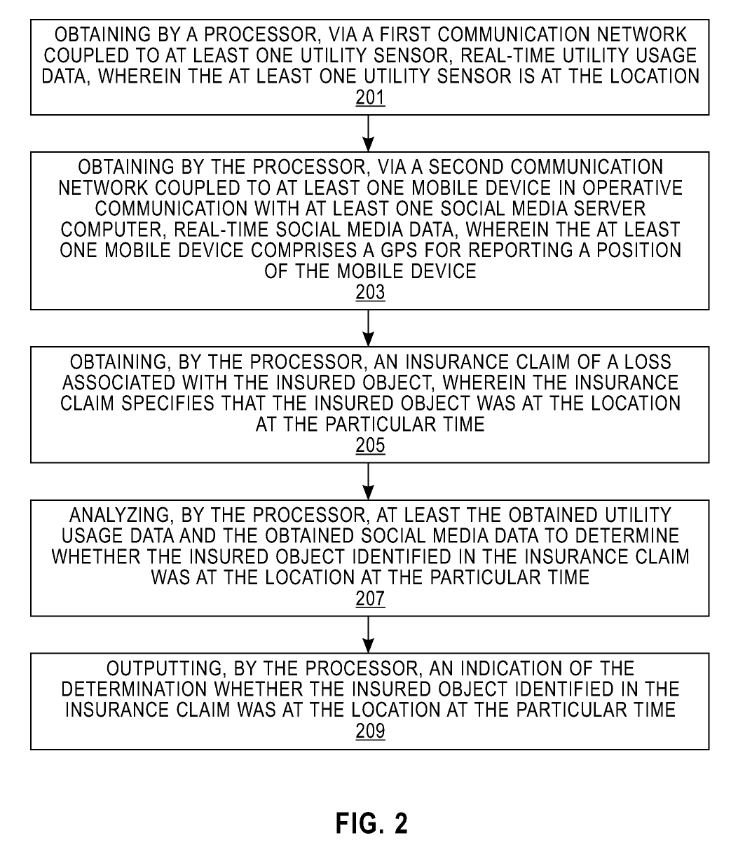

Referring now to FIG. 2, a method for assessing whether an insured object was at a location at a particular time is provided. As seen in this FIG. 2, the method of this embodiment comprises: at 201—obtaining by a processor, via a first communication network coupled to at least one utility sensor, real-time utility usage data, wherein the at least one utility sensor is at the location; at 203—obtaining by the processor, via a second communication network coupled to at least one mobile device in operative communication with at least one social media server computer, real-time social media data, wherein the at least one mobile device comprises a GPS (e.g., a GPS receiver) for reporting a position of the mobile device; at 205—obtaining, by the processor, an insurance claim of a loss associated with the insured object, wherein the insurance claim specifies that the insured object was at the location at the particular time; at 207—analyzing, by the processor, at least the obtained utility usage data and the obtained social media data to determine whether the insured object identified in the insurance claim was at the location at the particular time; and at 209—outputting, by the processor, an indication of the determination whether the insured object identified in the insurance claim was at the location at the particular time.

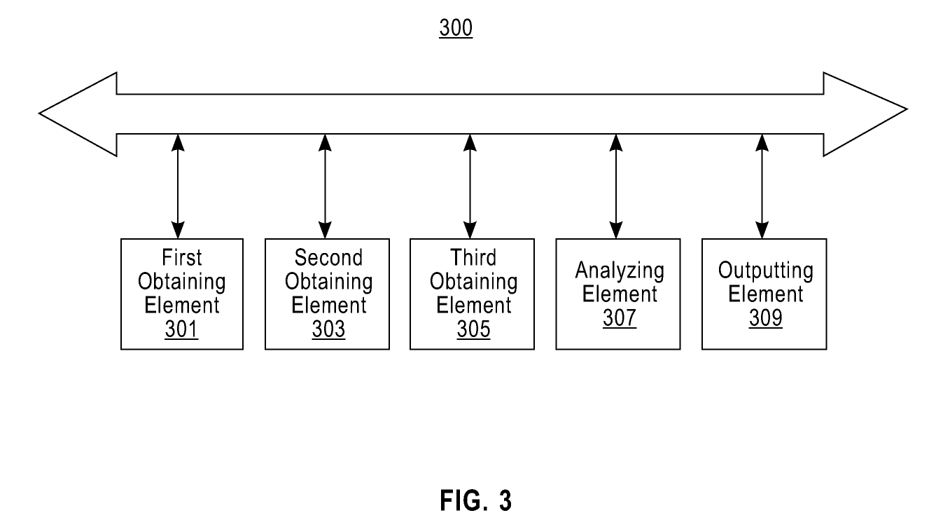

Referring now to FIG. 3, in another embodiment, a system 300 for assessing whether an insured item was at a location at a particular time is provided. This system may include a processor (not shown); and a memory (not shown) storing computer readable instructions that, when executed by the processor, implement: a first obtaining element 301 configured to obtain, via a first communication network coupled to at least one utility sensor, real-time utility usage data, wherein the at least one utility sensor is at the location; a second obtaining element 303 configured to obtain, via a second communication network coupled to at least one mobile device in operative communication with at least one social media server computer, real-time social media data, wherein the at least one mobile device comprises a GPS for reporting a position of the mobile device; a third obtaining element 305 configured to obtain an insurance claim of a loss associated with the insured object, wherein the insurance claim alleges that the insured object was at the location at the particular time; an analyzing element 307 configured to analyze at least the obtained utility usage data and the obtained social media data to determine whether the insured item identified in the insurance claim was at the location at the particular time; and an outputting element 309 configured to output an indication of the determination whether the insured item identified in the insurance claim was at the location at the particular time.

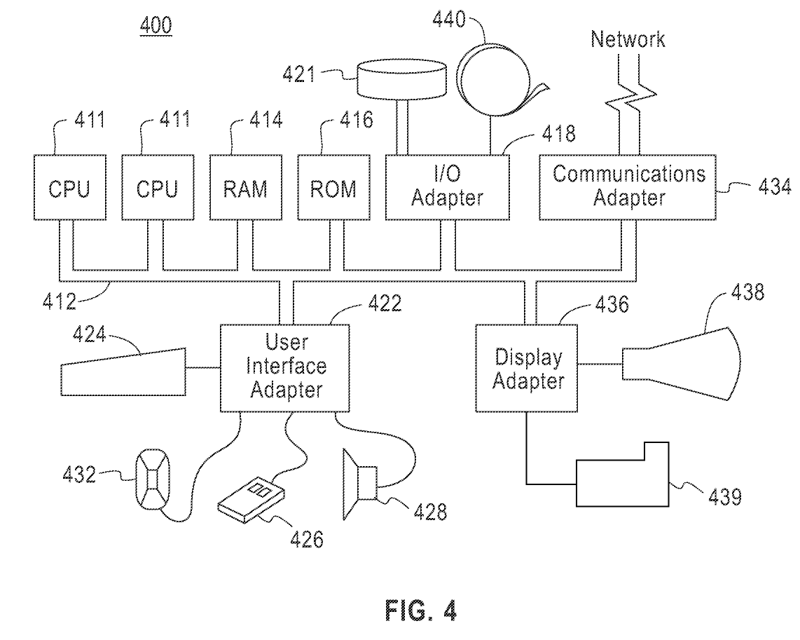

In one example, communication between and among the various components of FIG. 3 may be bi-directional. In another example, the communication may be carried out via the Internet, an intranet, a local area network, a wide area network and/or any other desired communication channel(s). In another example, each of the components may be operatively connected to each of the other components. In another example, some or all of these components may be implemented in a computer system of the type shown in FIG. 4.

Referring now to FIG. 4, this figure shows a hardware configuration of computing system 400 according to an embodiment of the present invention. As seen, this hardware configuration has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communications adapter 434 for connecting the system 400 to a data processing network, the Internet, an Intranet, a local area network (LAN), etc., and a display adapter 436 for connecting the bus 412 to a display device 438 and/or printer 439 (e.g., a digital printer or the like).

As described herein, mechanisms are provided for leveraging social media interactions and sensor devices in order to automatically and accurately assess insurance claims.

As described herein, mechanisms are provided to: (a) collect data in real-time from multiple sensors and other sources that affect implications of said data for insurance claims; (b) analyze the collected data as affecting validity of insurance claims; and (c) report result of analysis to interested parties.

As described herein, mechanisms are provided for monitoring of utilities usage to correlate with data from other sensors.

As described herein, mechanisms may be implemented by one or more insurance companies.

As described herein, mechanisms are provided to dynamically assess the presence or absence of people and insured items

As described herein, mechanisms are provided to utilize the “Internet of things” for the identification of presence and identification of objects.

As described herein, through dynamic assessment of the presence or absence of people and/or other insured items of value in an insured location (e.g., in an insured home), inaccurate claims made due to, for example, mishap and/or natural disaster may be determined and payment thereof may be reduced.

As described herein, various mechanisms utilize real-time data collected via real-time monitoring from multiple sources, including: a claimant (such as an insured); sensors; surveillance devices; utilities usage; smart appliances; wearable and/or portable devices; medical and/or location monitoring devices; and/or social media. The collected real-time data may be used in analyzing and reporting (such as insurance claim analysis and reporting to reduce or eliminate insurance fraud).

In another embodiment, mechanisms may be provided for off-site storage of the collected real-time data (e.g., off-site storage of video sensor data, audio sensor data, utility usage data, social media data).

In another embodiment, one or more sensors may be placed on the insured person or object. In another embodiment, one or more sensors may be placed not on the insured person or object but at a location permitting data collection relative to the insured person or object.

As described herein, the real-time information of the insured people and/or items enables one to track their location (and thereby, for example, reduce the number of fraudulent claims). In one specific example, the real-time information may be used to reduce the number of fraudulent claims in the scenario where a person/item may be hurt/damaged in an accident (or other incident) at a location not covered by an insurance policy and then the person/item is subsequently brought to a location that is covered by the insurance policy.

In another embodiment, the real-time information related to the insured people and/or items may automatically increase a confidence level (without having to perform modeling computations) that an insurance company may have that a claim is not fraudulent.

In other examples, real-time data may be collected from input sources comprising fixed electronic devices (such as home sensors and surveillance devices, utilities usage sensors, smart appliances).

In other examples, real-time data may be collected from input sources comprising mobile and portable electronic devices (such as smart phones and tablets).

In other examples, real-time data may be collected from input sources comprising wearable and/or portable electronic devices (such as health and medical monitors and/or locators).

In other examples, real-time data may be collected from input sources comprising non-wearable electronic devices (such as sensors configured to detect events (e.g. fire) and/or provide feedback for control (e.g. control of lighting, heating, air-conditioning, water usage, etc.).

In other examples, real-time data may be collected from social media tools (such as mobile applications, websites, blogs).

In other examples, real-time data may be collected from one or more people (such as an insured or claimant).

As described herein, data may be collected via a continuous collection of data.

In one specific example, the data collection, analysis and reporting may be carried out as follows: (a) collect data from sources specified herein; (b) analyze the data from (a) above using various machine learning techniques/algorithms (if required, apply facial recognition to images); (c) produce a table on the claimant's assets specifying asset location (that is, location during the incident and a current location) based on the analytics performed in (b) above; (d) analyze the table from (c) above and record observations; (e) accept or refute claim based on the analysis in (d) above; and (f) produce one or more reports based on (e) above.

In another embodiment, real-time data may be collected from a Social Context Information Management System (“SCIMS”). One example of such a SCIMS is found in M. A. Kabir, J. Han, J. Yu, and A. Colman, SCIMS: A Social Context Information Management System for Socially-Aware Applications, 24th International Conference on Advanced Information System Engineering (CAiSE 2012), Gdansk, Poland, Jun. 25-29, 2012, LNCS, Springer, Vol. 7328, pp. 301-317. More particularly, a SCIMS is an application that takes into account its user's situations inferred from social media in order to reduce, for example, call interruptions. The SCIMS enables the caller to check whether it is a suitable time to call, as well as provide automatic response to the caller based on the specified preferences e.g. response/ignore caller lists.

Certain details of how a SCIMS may be applied in a conventional manner are as follows: A user, User E, has installed a SCIMS application on her cell phone. She is about to give a lecture at University from 4 to 6 pm and shares this information on FACEBOOK. She does not want to be interrupted by any calls, however, she wants the caller to know the reason she is unable to answer any calls. The SCIMS application is able to infer from her FACEBOOK posts that she is giving a talk from 4 to 6 pm at University, filter incoming calls based on specified preferences, and inform the caller as appropriate. In addition, such an SCIMS is able to infer a user's location from pictures uploaded to social media to provide automatic response.

With respect to the insurance claim analysis techniques disclosed herein, the SCIMS application discussed above (along with any associated social media posts including, for example, pictures) may provide evidence of the location (and/or additional information) of insured people and/or items of value.

As described herein, people often take out insurance on assets that have financial and/or sentimental value. These assets may be, for example, jewelry, antiques, paintings, pets or other animals, automobiles. When insured, the insurance company typically has a list of assets that are located at a given premises (e.g., a home). People are also often insured against, for example, injuries, as may be pets or other animals. The various sensors, devices, appliances and social media tools disclosed herein can be used to dynamically assess the presence or absence of people and insured items of value (e.g., in an insured home).

In one embodiment, a computer-implemented method for assessing whether an insured object was at a location at a particular time is provided, the method comprising: obtaining by a processor, via a first communication network coupled to at least one utility sensor, real-time utility usage data, wherein the at least one utility sensor is at the location; obtaining by the processor, via a second communication network coupled to at least one mobile device in operative communication with at least one social media server computer, real-time social media data, wherein the at least one mobile device comprises a GPS for reporting a position of the mobile device; obtaining, by the processor, an insurance claim of a loss associated with the insured object, wherein the insurance claim specifies that the insured object was at the location at the particular time; analyzing, by the processor, at least the obtained utility usage data and the obtained social media data to determine whether the insured object identified in the insurance claim was at the location at the particular time; and outputting, by the processor, an indication of the determination whether the insured object identified in the insurance claim was at the location at the particular time.

In one example, the utility usage data is indicative of at least one of: (a) whether a utility was being used at the particular time; (b) how much of the utility was being used at the particular time; and (c) any combination thereof.

In another example, the utility usage data is related to a utility selected from one of: (a) an electric utility; (b) a natural gas utility; (c) a propane utility; (d) an oil utility; (e) a cable television utility; (f) a water utility; (g) an Internet access utility; and (h) any combination thereof.

In another example, the social media server computer operates to provide at least one of: (a) a social media website; (b) a social media blog; and (c) any combination thereof.

In another example, the mobile device is in operative communication with the social media server computer by use of a social media software application running on the mobile device.

In another example, the insured object is one of: (a) a person; (b) an animal; and (c) an inanimate object.

In another example, the insurance claim is obtained from an insured person.

In another example, the specified loss is one of: (a) a total loss of the insured object; and (b) damage to the insured object, the damage resulting in less than a total loss.

In another example, the location is a home of an insured person.

In another example, the method further comprises obtaining by the processor at least one of: (a) real-time audio data from at least one audio sensor at the location; and (b) real-time video data from at least one video sensor at the location; wherein the analyzing further comprises analyzing, by the processor, the obtained utility usage data, the obtained social media data, and at least one of the obtained audio data and the obtained video data to determine whether the insured object identified in the insurance claim was at the location at the particular time.

In another example, the method further comprises obtaining by the processor at least one of: (a) real-time audio data from at least one audio sensor in a vehicle; and (b) real-time video data from at least one video sensor in the vehicle; wherein the analyzing further comprises analyzing, by the processor, the obtained utility usage data, the obtained social media data, and at least one of the obtained audio data and the obtained video data to determine whether the insured object identified in the insurance claim was at the location at the particular time.

In another example: the processor is located remotely from the location; the processor is in operative communication with the at least one utility sensor at the location to obtain the real-time utility usage data; the processor is located remotely from where the at least one social media source is disposed; and the processor is in operative communication with the at least one social media source to obtain the real-time social media data.

In another example: the processor is in operative communication with the at least one utility sensor via the Internet; and the processor is in operative communication with the at least one social media source via the Internet.

In another embodiment, a computer readable storage medium, tangibly embodying a program of instructions executable by the computer for assessing whether an insured object was at a location at a particular time is provided, the program of instructions, when executing, performing the following steps: obtaining, via a first communication network coupled to at least one utility sensor, real-time utility usage data, wherein the at least one utility sensor is at the location; obtaining, via a second communication network coupled to at least one mobile device in operative communication with at least one social media server computer, real-time social media data, wherein the at least one mobile device comprises a GPS for reporting a position of the mobile device; obtaining an insurance claim of a loss associated with the insured object, wherein the insurance claim specifies that the insured object was at the location at the particular time; analyzing at least the obtained utility usage data and the obtained social media data to determine whether the insured object identified in the insurance claim was at the location at the particular time; and outputting an indication of the determination whether the insured object identified in the insurance claim was at the location at the particular time.

In one example, the location is a home of an insured person.

In another example, the program of instructions, when executing, further performs the step of obtaining at least one of: (a) real-time audio data from at least one audio sensor at the location; and (b) real-time video data from at least one video sensor at the location; wherein the analyzing further comprises analyzing the obtained utility usage data, the obtained social media data, and at least one of the obtained audio data and the obtained video data to determine whether the insured object identified in the insurance claim was at the location at the particular time.

In another example, the program of instructions, when executing, further performs the step of obtaining at least one of: (a) real-time audio data from at least one audio sensor in a vehicle; and (b) real-time video data from at least one video sensor in the vehicle; wherein the analyzing further comprises analyzing the obtained utility usage data, the obtained social media data, and at least one of the obtained audio data and the obtained video data to determine whether the insured object identified in the insurance claim was at the location at the particular time.

In another embodiment, a computer-implemented system for assessing whether an insured object was at a location at a particular time is provided, the system comprising: a processor; and a memory storing computer readable instructions that, when executed by the processor, implement: obtaining, via a first communication network coupled to at least one utility sensor, real-time utility usage data, wherein the at least one utility sensor is at the location; obtaining, via a second communication network coupled to at least one mobile device in operative communication with at least one social media server computer, real-time social media data, wherein the at least one mobile device comprises a GPS for reporting a position of the mobile device; obtaining an insurance claim of a loss associated with the insured object, wherein the insurance claim alleges that the insured object was at the location at the particular time; analyzing at least the obtained utility usage data and the obtained social media data to determine whether the insured object identified in the insurance claim was at the location at the particular time; and outputting an indication of the determination whether the insured object identified in the insurance claim was at the location at the particular time.

In one example, the computer readable instructions, when executed by the processor, further perform the step of obtaining at least one of: (a) real-time audio data from at least one audio sensor at the location; and (b) real-time video data from at least one video sensor at the location; wherein the analyzing further comprises analyzing the obtained utility usage data, the obtained social media data, and at least one of the obtained audio data and the obtained video data to determine whether the insured object identified in the insurance claim was at the location at the particular time.

In another example, the computer readable instructions, when executed by the processor, further perform the step of obtaining at least one of: (a) real-time audio data from at least one audio sensor in a vehicle; and (b) real-time video data from at least one video sensor in the vehicle; wherein the analyzing further comprises analyzing the obtained utility usage data, the obtained social media data, and at least one of the obtained audio data and the obtained video data to determine whether the insured object identified in the insurance claim was at the location at the particular time.

In other examples, any steps described herein may be carried out in any appropriate desired order.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for assessing whether an insured object was at a location at a particular time, the method comprising:
obtaining by a processor, via a first communication network coupled to at least one utility sensor, real-time utility usage data, wherein the at least one utility sensor is at the location;
obtaining by the processor, via a second communication network coupled to at least one mobile device in operative communication with at least one social media server computer, real-time social media data, wherein the at least one mobile device comprises a GPS for reporting a position of the mobile device;
obtaining, by the processor, an insurance claim of a loss associated with the insured object, wherein the insurance claim specifies that the insured object was at the location at the particular time;
analyzing, by the processor, at least the obtained utility usage data and the obtained social media data to determine whether the insured object identified in the insurance claim was at the location at the particular time; and
outputting, by the processor, an indication of the determination whether the insured object identified in the insurance claim was at the location at the particular time,
the utility sensor containing an embedded processor for controlling and monitoring utility usage, the utility sensor coupled to a smart home appliance, wherein the processor comprises a central control system providing remote access for the controlling and monitoring the smart home appliance, the processor further monitoring the mobile device, the processor integrating real-time communications from the monitoring of the smart home appliance and the mobile device in determining whether the insured object was at the location at the particular time.

2. The method of claim 1, wherein the utility usage data is indicative of at least one of: (a) whether a utility was being used at the particular time; (b) how much of the utility was being used at the particular time; and (c) any combination thereof.

3. The method of claim 1, wherein the utility usage data is related to a utility selected from one of: (a) an electric utility; (b) a natural gas utility; (c) a propane utility; (d) an oil utility; (e) a cable television utility; (f) a water utility; (g) an Internet access utility; and (h) any combination thereof.

4. The method of claim 1, wherein the social media server computer operates to provide at least one of: (a) a social media website; (b) a social media blog; and (c) any combination thereof.

5. The method of claim 1, wherein the mobile device is in operative communication with the social media server computer by use of a social media software application running on the mobile device.

6. The method of claim 1, wherein the insured object is one of: (a) a person; (b) an animal; and (c) an inanimate object.

7. The method of claim 1, wherein the insurance claim is obtained from an insured person.

8. The method of claim 1, wherein the specified loss is one of: (a) a total loss of the insured object; and (b) damage to the insured object, the damage resulting in less than a total loss.

9. The method of claim 1, wherein the location is a home of an insured person.

10. The method of claim 1, further comprising obtaining by the processor at least one of: (a) real-time audio data from at least one audio sensor at the location; and (b) real-time video data from at least one video sensor at the location;
wherein the analyzing further comprises analyzing, by the processor, the obtained utility usage data, the obtained social media data, and at least one of the obtained audio data and the obtained video data to determine whether the insured object identified in the insurance claim was at the location at the particular time.

11. The method of claim 1, further comprising obtaining by the processor at least one of: (a) real-time audio data from at least one audio sensor in a vehicle; and (b) real-time video data from at least one video sensor in the vehicle;
wherein the analyzing further comprises analyzing, by the processor, the obtained utility usage data, the obtained social media data, and at least one of the obtained audio data and the obtained video data to determine whether the insured object identified in the insurance claim was at the location at the particular time.

12. The method of claim 1, wherein:
the processor is located remotely from the location;
the processor is in operative communication with the at least one utility sensor at the location to obtain the real-time utility usage data;
the processor is located remotely from where the at least one social media source is disposed; and
the processor is in operative communication with the at least one social media source to obtain the real-time social media data.

13. The method of claim 12, wherein:
the processor is in operative communication with the at least one utility sensor via the Internet; and
the processor is in operative communication with the at least one social media source via the Internet.

14. A computer readable storage medium, tangibly embodying a program of instructions executable by the computer for assessing whether an insured object was at a location at a particular time, the program of instructions, when executing, performing the following steps:
obtaining, via a first communication network coupled to at least one utility sensor, real-time utility usage data, wherein the at least one utility sensor is at the location;
obtaining, via a second communication network coupled to at least one mobile device in operative communication with at least one social media server computer, real-time social media data, wherein the at least one mobile device comprises a GPS for reporting a position of the mobile device;
obtaining an insurance claim of a loss associated with the insured object, wherein the insurance claim specifies that the insured object was at the location at the particular time;
analyzing at least the obtained utility usage data and the obtained social media data to determine whether the insured object identified in the insurance claim was at the location at the particular time; and
outputting an indication of the determination whether the insured object identified in the insurance claim was at the location at the particular time,
the utility sensor containing an embedded processor for controlling and monitoring utility usage, the utility sensor coupled to a smart home appliance, wherein the processor comprises a central control system providing remote access for the controlling and monitoring the smart home appliance, the processor further monitoring the mobile device, the processor integrating real-time communications from the monitoring of the smart home appliance and the mobile device in determining whether the insured object was at the location at the particular time.

15. The computer readable storage medium of claim 14, wherein the location is a home of an insured person.

16. The computer readable storage medium of claim 14, wherein the program of instructions, when executing, further performs the step of obtaining at least one of: (a) real-time audio data from at least one audio sensor at the location; and (b) real-time video data from at least one video sensor at the location;
wherein the analyzing further comprises analyzing the obtained utility usage data, the obtained social media data, and at least one of the obtained audio data and the obtained video data to determine whether the insured object identified in the insurance claim was at the location at the particular time.

17. The computer readable storage medium of claim 14, wherein the program of instructions, when executing, further performs the step of obtaining at least one of: (a) real-time audio data from at least one audio sensor in a vehicle; and (b) real-time video data from at least one video sensor in the vehicle;
wherein the analyzing further comprises analyzing the obtained utility usage data, the obtained social media data, and at least one of the obtained audio data and the obtained video data to determine whether the insured object identified in the insurance claim was at the location at the particular time.

18. A computer-implemented system for assessing whether an insured object was at a location at a particular time, the system comprising:
a processor, the processor coupled to a plurality of devices comprising at least one utility sensor, at least one mobile device and at least one social media server computer, the processor coupled to a first communication network and a second communication network, the processor communicating real-time with the plurality of devices over at least one of the first communication network and the second communication network; and
a memory storing computer readable instructions that, when executed by the processor, implement:
obtaining, via the first communication network coupled to the at least one utility sensor, real-time utility usage data, wherein the at least one utility sensor is at the location;
obtaining, via the second communication network coupled to the at least one mobile device in operative communication with the at least one social media server computer, real-time social media data, wherein the at least one mobile device comprises a GPS for reporting a position of the mobile device;
obtaining an insurance claim of a loss associated with the insured object, wherein the insurance claim alleges that the insured object was at the location at the particular time;
analyzing at least the obtained utility usage data and the obtained social media data to determine whether the insured object identified in the insurance claim was at the location at the particular time; and
outputting an indication of the determination whether the insured object identified in the insurance claim was at the location at the particular time,
the utility sensor containing an embedded processor for controlling and monitoring utility usage, the utility sensor coupled to a smart home appliance, wherein the processor comprises a central control system providing remote access for the controlling and monitoring the smart home appliance, the processor further monitoring the mobile device, the processor integrating real-time communications from the monitoring of the smart home appliance and the mobile device in determining whether the insured object was at the location at the particular time.

19. The system of claim 18, wherein the computer readable instructions, when executed by the processor, further perform the step of obtaining at least one of: (a) real-time audio data from at least one audio sensor at the location; and (b) real-time video data from at least one video sensor at the location;
wherein the analyzing further comprises analyzing the obtained utility usage data, the obtained social media data, and at least one of the obtained audio data and the obtained video data to determine whether the insured object identified in the insurance claim was at the location at the particular time.

20. The system of claim 18, wherein the computer readable instructions, when executed by the processor, further perform the step of obtaining at least one of: (a) real-time audio data from at least one audio sensor in a vehicle; and (b) real-time video data from at least one video sensor in the vehicle;
wherein the analyzing further comprises analyzing the obtained utility usage data, the obtained social media data, and at least one of the obtained audio data and the obtained video data to determine whether the insured object identified in the insurance claim was at the location at the particular time.
